(19) United States
(12) Patent Application Publication
(10) Pub. No.: US 2004/0163961 A1
(43) Pub. Date: Aug. 26, 2004

(54) Apparatus and method for using bi-directional capillary electrophoresis

(75) Inventor: Aaron T. Timperman, Morgantown, WV (US)

Correspondence Address: PALMER & DODGE, LLP, PAULA CAMPBELL EVANS, 111 HUNTINGTON AVENUE, BOSTON, MA, 02199, US

(73) Assignee: West Virginia University Research Corporation

(21) Appl. No.: 10/784,352

(22) Filed: Feb. 23, 2004

Related U.S. Application Data
(60) Provisional application No. 60/449,338, filed on Feb. 21, 2003.

(51) Int. Cl. G01N 27/453

(52) U.S. Cl. 204/451; 204/601

(57) ABSTRACT

The present invention provides an apparatus and method of utilizing bi-directional capillary electrophoresis (“CE”) device. In one embodiment, cations are drawn into a first uncharged channel towards a negative electrode and anions are drawn into a second uncharged channel towards a positive electrode. The uncharged channels allows for minimal interaction between the sample and the walls of the channel which allows for minimal sample loss. The present invention also provides a method of separating anions from cations. The method comprises delivering the mixture to a bi-directional CE device. Following delivery, cations are drawn into a first uncharged channel towards a negative electrode and anions are drawn into a second uncharged channel towards a positive electrode. In one aspect of the present invention, the bi-directional CE device engages a microfluidic proteome analysis system.

### RELATED APPLICATIONS

This application claims the benefit of U.S. Provisional Application No. 60/449,338 filed on Feb. 21, 2003. The entire teachings of the above application(s) are incorporated herein by reference.

### FIELD OF THE INVENTION

The present invention relates to the field of capillary electrophoresis and sample separations. More specifically, the present invention provides an apparatus and method of utilizing bi-directional capillary electrophoresis to simultaneously separate anions and cations from a sample thus eliminating the need for electroosmotic flow used in conventional capillary electrophoresis.

### BACKGROUND OF THE INVENTION

The goal of proteomics is to identify and quantitate the proteins expressed in a cell as a means of addressing the complexity of biological systems. Current methods for proteome analysis generally are based on the use of two-dimensional electrophoresis (“2DE”) to identify cellular proteins. Protein patterns on 2DE gels are analyzed using image analysis techniques to generate proteome maps. Proteome maps of normal cells and diseased cells are compared to detect proteins that are up-regulated or down-regulated during physiological responses to disease. These proteins are excised for identification and characterization, using such methods as mass fingerprinting and mass spectrometry.

However, using current 2DE methods, only the most abundant proteins can be identified. Thus, most of the proteins identified by 2DE methods represent structural proteins or housekeeping proteins (see, e.g., Gygi et al., 2000, Proc. Natl. Acad. Sci. USA 97: 9390-9395; Gygi et al., 1999, Electrophoresis 20: 310-319; Shevchenko, 1996, Proc. Nat. Acad. Sci. USA 93: 14440-14445; Boucherie, 1996, Electrophoresis 17(11): 1683-1699; Ducret, 1998, Protein Science 7: 706-719; Garrels, 1994, Electrophoresis 15: 1466-1486). These problems have limited the use of proteomics for the identification of cancer markers because the lower abundance proteins that produce aberrant cell signals cannot be qualified, making it difficult to elucidate mechanisms that cause disease states and identify suitable cancer-specific markers.

The lack of sensitivity of current 2DE-based technology is caused primarily by a lack of separating or resolving power because high abundance proteins mask the identification of low abundance proteins. Loading more protein on the gels does not improve the situation because the Gaussian tails of the high abundance spots contaminate the low abundance proteins. The use of zoom gels (2DE gels that focus on a narrow pH range) allows for minimal gains (Gygi, 2000, supra) but is considered too cumbersome to be of any practical utility (Corthals, 2000, Electrophoresis 21: 1104-1115). Selective enrichment methods also can be used but generally at the expense of obtaining a comprehensive view of cellular protein expression. The sensitivity of detection on 2DE gels also is problematic, because the amount of protein required for identification by mass spectrometry (“MS”) is near the detection limits of the most sensitive methods for visualization of the protein spots on the 2DE gels. Further, the polyacrylamide matrix typically used in 2DE gives rise to a significant amount of background in the extracted sample mixture making subsequent analysis by MS difficult (Kinter, 2000, In Protein Sequencing and Identification Using Tandem Mass Spectrometry, Wiley, N.Y.). Additionally, during peptide extraction following typical in-gel digestion procedures, the sample is exposed to many surfaces and losses can be substantial, particularly for low abundance proteins (Timperman, 2000, Anal. Chem. 72: 4115-4121; Kinter, supra).

Multi-dimensional column separations offer many advantages over 2DE, including a higher separating power and reduced sample contamination and loss. A typical large format 2DE gel is capable of achieving a peak capacity of about 2,000 while 2DE column separations can achieve peak capacities of over 20,000 for protein separations. Additionally, the stationary phases of these columns are very stable and non-reactive compared to polyacrylamide gels, leading to reduced sample contamination and loss. Many different types of separation techniques have been coupled to 2DE column separations including size exclusion, reversed phase chromatography, cation-exchange chromatography, and capillary electrophoresis (Wall, 2000, Analytical Chemistry 72: 1099-1111; Link, 1999, Nature Biotechnology 17: 676-682; Opiteck, 1998, Journal of Microcolumn Separations 10: 365-375; Hooker et al., 1998, In High-Performance Capillary Electrophoresis, John Wiley & Sons Inc, New York, Vol. 146, pp 581-612; Opiteck et al., 1998, Analytical Biochemistry 258: 349-361; Vissers, 1999, Journal of Microcolumn Separations 11: 277-286.; Liu et al., 1996, Anal. Chem. 68: 3928-3933.). Further increases in peak capacity have been achieved using three-dimensional columns (see, e.g., Moore, 1995, supra).

Microfluidic devices are finding many applications for DNA analysis, but there has been little development of these devices for protein analysis. The microfluidic device revolution was begun by Harrison, 1992, Analytical Chemistry 64: 1926-1932, who demonstrated valveless electrophoretic separation and fluid manipulation on such devices. Much recent work has focused on the basics of sample injection, on-device column fabrication and interfacing with mass spectrometry.

There is a need in the art for a device capable of allowing both anionic and cationic species to be separated in an uncharged capillary or column without electroosmotic flow. Allowing a sample to be separated in an uncharged capillary or column minimizes the amount of interaction between the sample and the walls of the capillary or column and leads to less sample loss. In addition, there is a need in the art for a device capable of simultaneously separating anions and cations from a sample wherein the device can be incorporated into a microfluidic device or operate in a stand alone fashion.

### SUMMARY OF THE INVENTION

The present invention provides an apparatus and method of utilizing bi-directional capillary electrophoresis (“CE”). In one aspect of the invention, the bi-directional CE device comprises an uncharged capillary or column. In one aspect of the present invention, the uncharged capillary or column allows for minimal interaction between the sample and the walls of the capillary or column. The minimal interaction between the sample and the uncharged capillary or column allows for minimal sample loss. In one aspect of the invention, the capillary or column is coated to minimize the charge on the capillary or column. In one aspect of the invention, electroosmotic flow is minimized in the capillary or column. In one aspect of the invention, cations and anions are simultaneously separated from the sample.

In one aspect of the present invention, the bi-directional capillary electrophoresis device uses two separation capillaries with a central origin and opposite polarities for the electrodes at the end of each separation channel. In one aspect of the present invention, the bi-directional CE device allows for the separation of both anions and cations at low or no electroosmotic flow (“EOF”) in different channels. In one aspect of the present invention, the bi-directional CE device can be fabricated on a microchip or with glass capillaries. In one aspect of the present invention, a low or no EOF is used with the coating of capillaries and microchannels to minimize analyte adsorption to the capillary walls. The generation of electroosmotic flow requires the presence of ionizable groups on the surface of the capillary or the microchannel walls. However, these ionizable groups also lead to unwanted charge based interactions that can lead to sample loss and peak broadening. Minimizing or negating charge interactions at the wall/solution (solid/liquid) interface is necessary to avoid these interactions. In one aspect of the present invention, the bi-directional CE device enables the use of coatings that negate or minimize the EOF while allowing simultaneous separation of anions and cations. In a further aspect of the present invention, the bi-directional CE device can provide an effective interface between an upstream separation and a downstream CE separation to function as an effective interface for a multi-dimensional separation.

In one embodiment of the present invention, the bi-directional CE devices engages an integrated microfluidic proteome analysis system and method for rapidly analyzing large numbers of compounds or complex mixtures of compounds, particularly low abundance cellular proteins involved in cell signaling pathways. The system may also be used to analyze analyte mixtures other than peptides including, but not limited to, organic in dissolved organic matter sample from natural waters and organic matter from coal. The system comprises a number of modular components which can be used in an integrated fashion, separately, or in conjunction with other systems.

In one aspect of the present invention, the bi-directional CE device allows for simultaneous separation of anions and cations. In a further embodiment of the present invention, the separated anions are delivered to an integrated microfluidic system analysis. In another aspect of the present invention, the separated cations are delivered to a second integrated microfluidic system for analysis.

The present invention provides a method of eliminating the need for EOF in a capillary or a microchip used for capillary electrophoresis. Further, the method of the present invention allows for an uncharged capillary or column to be utilized in a CE process. An uncharged capillary or column allows for less interaction between the analytes and the column. Biological samples, such as but not limited to polypeptides, have many unwanted ionic interactions with the surface of the capillary column. As such, less analytes are lost during the procedure allowing the user to begin with a smaller amount of sample to be separated than has been customarily used in connection with the prior art. In addition, the present invention provides a method which allows for the simultaneous separation of anions and cations.

### BRIEF DESCRIPTION OF THE DRAWINGS

The present invention will be further explained with reference to the attached drawings, wherein like structures are referred to by like numerals throughout the several views. The drawings shown are not necessarily to scale, with emphasis instead generally being placed upon illustrating the principles of the present invention.

FIG. 1 shows a conventional capillary electrophoresis schematic.

FIG. 2 shows a conventional manner of integrating capillary electrophoresis onto a microchip.

FIG. 3 shows a schematic of the bi-directional capillary electrophoresis device of the present invention.

FIG. 4 shows a schematic of an alternative embodiment of the bidirectional capillary electrophoresis device of the present invention.

FIG. 5 shows an embodiment of the present invention in wherein the bi-directional capillary electrophoresis device of the present invention is in communication with an integrated microfluidic system for proteome analysis.

FIG. 6 shows an embodiment of the present invention comprising a hydrodynamic flow resistor.

FIG. 7 shows an embodiment of the present invention comprising a dual channel detector.

While the above-identified drawings set forth preferred embodiments of the present invention, other embodiments of the present invention are also contemplated, as noted in the discussion. This disclosure presents illustrative embodiments of the present invention by way of representation and not limitation. Numerous other modifications and embodiments can be devised by those skilled in the art which fall within the scope and spirit of the principles of the present invention.

### DETAILED DESCRIPTION

The present invention provides an apparatus and method of utilizing bi-directional capillary electrophoresis (“CE”). In one aspect of the invention, the bi-directional CE device comprises an uncharged capillary or column. In one aspect of the present invention, the uncharged capillary or column allows for minimal interaction between the sample and the walls of the capillary or column. The minimal interaction between the sample and the uncharged capillary or column allows for minimal sample loss. In one aspect of the invention, the capillary or column is coated so as to minimize the charge on the capillary or column. In one aspect of the invention, electroosmotic flow is minimized in the capillary or column. In one aspect of the invention, cations and anions are simultaneously separated from the sample.

In one aspect of the present invention, the bi-directional capillary electrophoresis device uses two separation capillaries with a central origin and opposite polarities for the electrodes at the end of each separation channel. In one aspect of the present invention, the bi-directional CE device allows for the separation of both anions and cations at low or no electroosmotic flow (“EOF”) in different channels. In one aspect of the present invention, the bi-directional CE device can be fabricated on a microchip or with glass capillaries. The use of low or no EOF is of increasing importance as advancements are being made in the coating of capillaries and microchannels to minimize analyte adsorption to the capillary walls. The generation of electroosmotic flow requires the presence of ionizable groups on the surface of the capillary or the microchannel walls. However, these ionizable groups also lead to unwanted charge based interactions that can lead to sample loss and peak broadening. Minimizing or negating charge interactions at the wall/solution (solid/liquid) interface is necessary to avoid these interactions. In one aspect of the present invention, the bi-directional CE device enables the use of coatings that negate or minimize the EOF while allowing simultaneous separation of anions and cations. In a further aspect of the present invention, the bi-directional CE device can provide an effective interface between an upstream separation and a downstream CE separation to function as an effective interface for a multi-dimensional separation.

The present invention provides a method of eliminating the need for EOF flow in a capillary or a microchip used for capillary electrophoresis. Further, the method of the present invention allows for an uncharged capillary or column to be utilized in a CE process. An uncharged capillary or column allows for less interaction between the analytes and the column. As such, less analytes are lost during the procedure allowing the user to begin with a smaller amount of sample to be separated than has been customarily used in connection with the prior art. In addition, the present invention provides a method which allows for the simultaneous separation of anions and cations.

Definitions

The following terms and definitions are used herein:

As used herein, “a sample band” or “sample plug” refers to a volume of a fluid which comprises a sample.

As used herein, “electrophoresis” refers to an electrochemical process in which colloidal particles or macromolecules or small molecules or other ionic species with a net electric charge migrate in a solution under the influence of an electric current.

As used herein, “electrophoretic mobility” refers to the movement of charge particles in an electric field to the positive or negative electrode through a viscous medium, because of the charge of these substances.

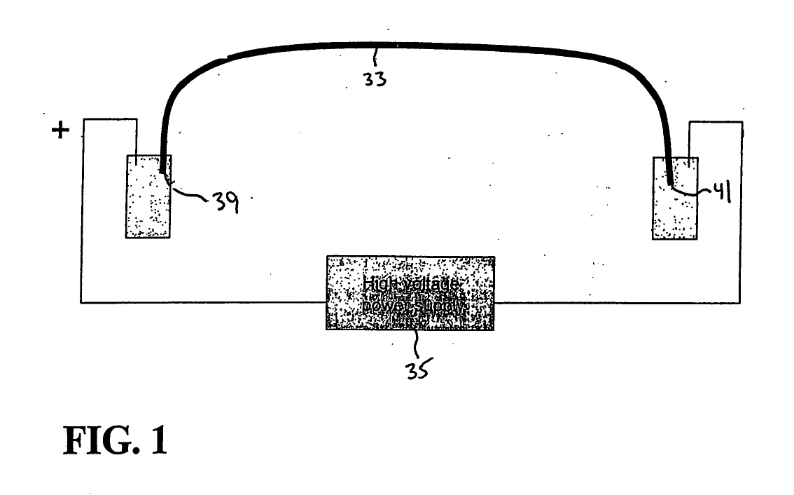

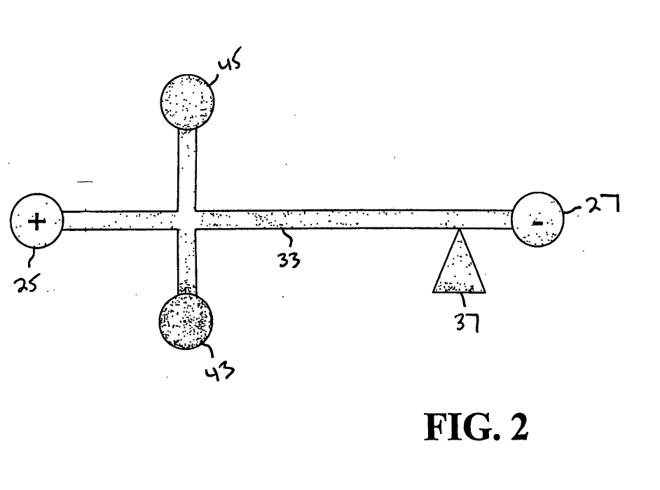

FIG. 1 shows a conventional device capable of capillary electrophoresis utilizing electroosmotic flow (“EOF”) to move a sample from an inlet buffer vial 39 to an outlet buffer vial 41. In conventional capillary electrophoresis, both the anions and the cations are swept toward a detector (shown in FIG. 2) by an electroosmotic flow because the electroosmotic flow is greater in magnitude than electrophoretic migration in the reverse direction. However, when the electroosmotic flow is lower in magnitude than the electrophoretic mobility the reverse migration excludes either the anions or the cations (depending on the electrode polarity) from the separation capillary of the channel. In order to obtain the needed amount of EOF to drive the sample through the capillary or channel surface 33, the capillary 33 needs to possess a charge. In producing such a charge, anions or cations (depending on the charge of the capillary 33) are attracted to the wall and as a result, a portion of the sample is lost.

FIG. 1 shows a high voltage power supply 35 used to create a potential difference between an inlet buffer vial 39 and an outlet buffer vial 41. The potential difference is used to generate a sufficient amount of EOF necessary to drive a sample through a charged capillary 33 from an inlet buffer vial 39 to an outlet buffer vial 41. As illustrated in FIG. 1, an anion electrophoretic mobility is generated towards the positive electrode and a cation electrophoretic mobility is generated toward the negative electrode. FIG. 1 shows the most conventional polarity, i.e., a polarity which allows the EOF to move toward the outlet. This is the conventional polarity because the wall of the capillary 33 is usually negative. A negative wall of a capillary 33 creates a positive diffuse layer which migrates toward the outlet buffer vial 41 producing the EOF. If a positively charged wall is used the EOF and the polarity are usually reversed.

FIG. 2 shows a conventional diagram of capillary electrophoresis integrated onto a microchip. Electroosmotic flow is generated through use of a charged capillary 33, a positive electrode 25, and a negative electrode 27. As such, an anion electrophoretic mobility is generated toward the positive electrode and a cation electrophoretic mobility is generated in the direction of the negative electrode. A sample enters the device through a sample port 43. In addition, sample waste is collected in a sample waste port 45. Electroosmotic flow drives the sample in a direction towards the negative electrode 27 and past a detector 37 which is positioned to detect the anions and cations in a particular sample.

The use of no or low electroosmotic is of increasing importance as advancements are being made in the coating of capillaries and microchannels to minimize analyte adsorption to the capillary or microchannel walls. Such coatings allow for minimal interaction between samples and the walls of the device; less interaction relates to smaller sample losses. Reducing sample loss means smaller quantities of starting materials can be utilized. The generation of electroosmotic flow requires the presence of ionizable groups on the surface of the capillary or microchannel channel walls. However, these ionizable groups also lead to unwanted to charge based interactions that can lead to sample loss and peak broadening. Minimizing or negating charge interactions at the capillary or microchannel wall/solution (solid/liquid) interface is necessary to avoid these interactions.

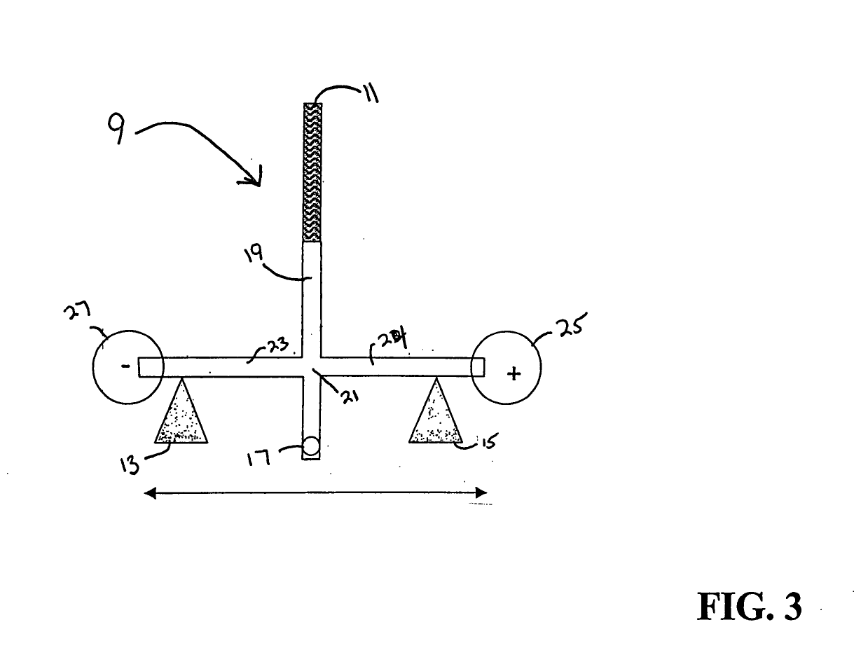

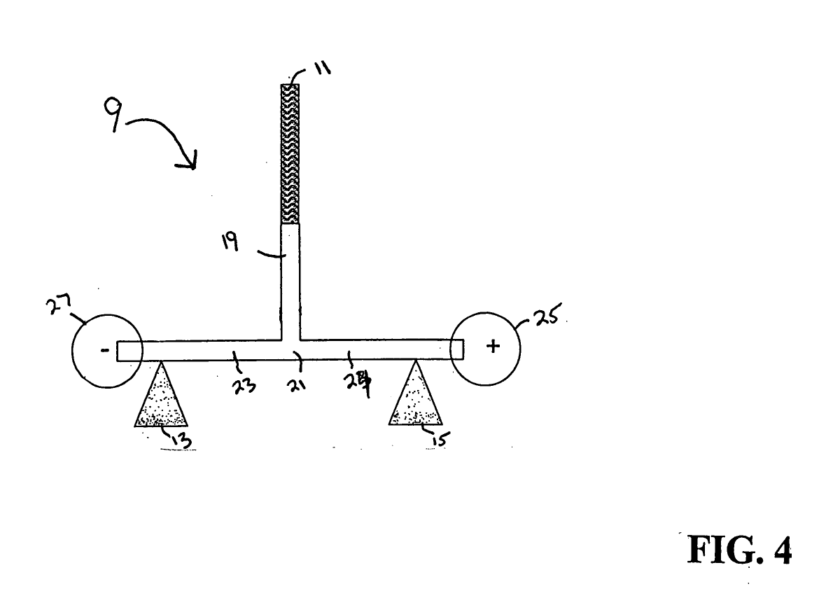

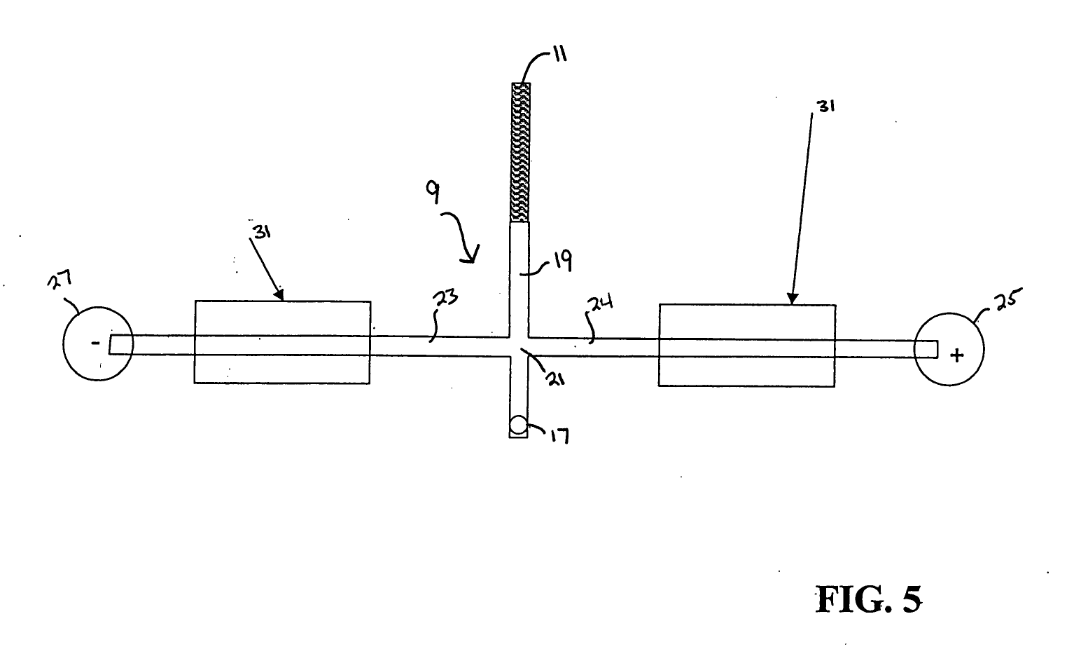

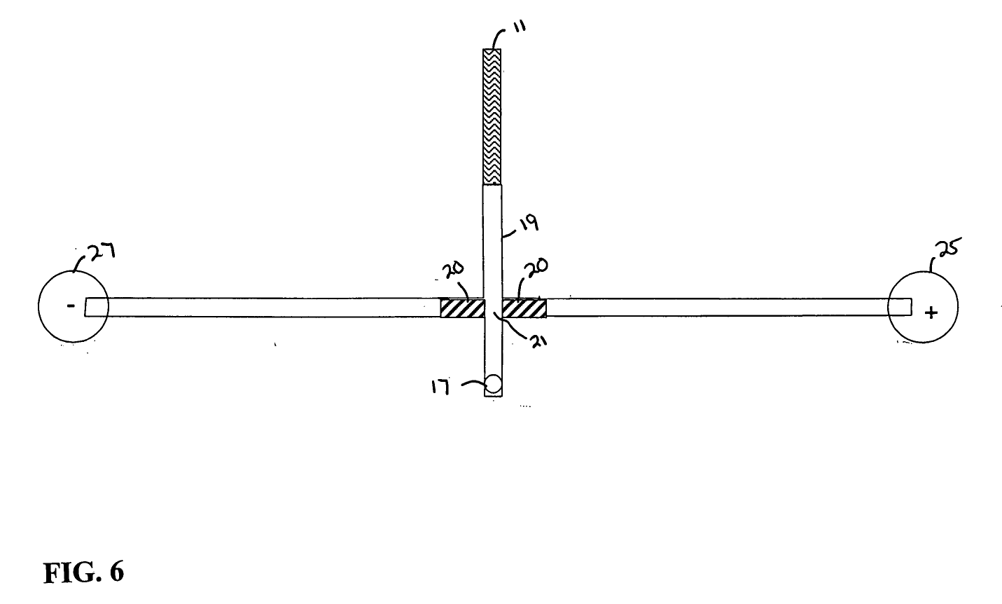

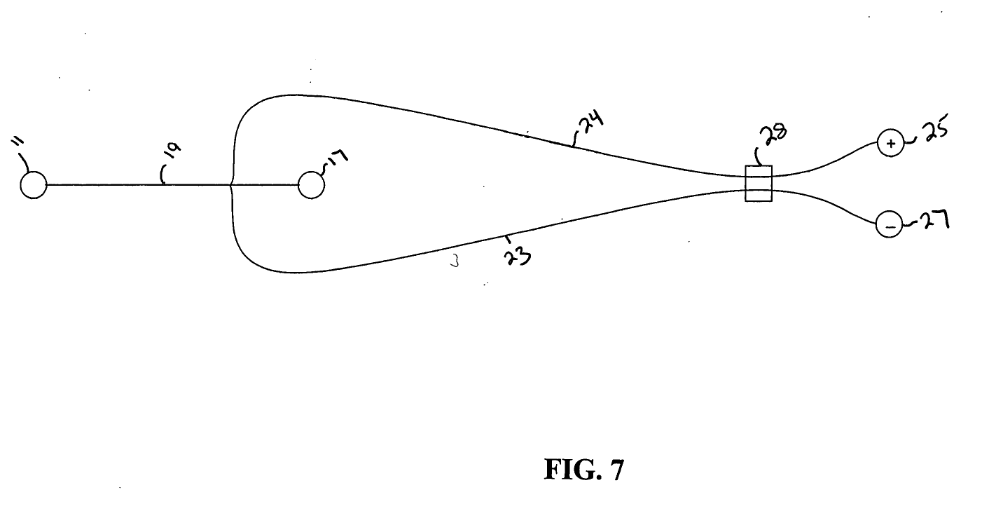

FIG. 3, FIG. 4, FIG. 5, FIG. 6, and FIG. 7 shows a device that enables the use of coatings that negates or minimizes the EOF while allowing simultaneous separation of anions and cations. The device can also provide an effective interface between an upstream separation and a downstream CE separation to function as an effective interface for a multi-dimensional separation.

FIG. 3 shows a general representation of a bi-directional capillary separation device 9 of the present invention. In one aspect of the present invention, a sample is injected through an inlet 11 into a middle column 19 of the bi-directional capillary separation device 9. In one embodiment of the present invention, the sample travels down the middle column 19 until it reaches an intersection point 21. When the sample reaches the intersection point 21, cations and anions of the sample are simultaneously separated. In one aspect of the present invention, cations are drawn down a first channel 23 due to the presence of a negative electrode 27. In one embodiment, the cations pass a detector 13 on their way down the first channel 23. In a further aspect of the present invention, the first channel 23 is coated so that the first channel 23 has no charge. In another embodiment, the first channel 23 has a slight charge. In one aspect of the present invention, anions are drawn down a second channel 24 due to the presence of a positive electrode 25. In one embodiment, the anions pass a detector 15 on their way down the second channel 24. In a further aspect of the present invention, the second channel 24 is coated so that the second channel 24 has no charge. In another embodiment, the second channel 24 has a slight charge.

Many coatings including but not limited to, Triton X 100, may be used to coat the channels 23, 24. Those of skill in the art will recognize that many coatings are within the spirit and scope of the present invention. There are many types of coatings, including but not limited to, dynamic coatings, covalent modifications to the channel surface, and self-assembled monolayers.

As shown in FIG. 6, the design may include a hydrodynamic flow resistor 20 at the beginning of each CE channel 23, 24. The hydrodynamic flow resistor 20 reduces or eliminates the bulk flow of solution through the capillary electrophoresis channels 23, 24. There are various types of hydrodynamic flow resistors which include but are not limited to frits, packed beads with uncharged beads, restrictions in the channel size, or the use of multiple small channels in parallel.

As mentioned above, in a preferred aspect of the present invention a detector 13, 15 may be used to determine the presence of an anion or a cation. In one aspect, detectors 13, 15 are placed at various flow points of the bi-directional CE device 9 to enable a user to monitor separation efficiency. In a future embodiment of the present invention, the device 9 may comprise a plurality of detectors. For example, one or more spectroscopic detectors 13, 15 can be positioned in communication with various channels, outputs and/or modules of the bi-directional CE system 9. Spectroscopic detectors rely on a change in refractive index, ultraviolet and/or visible light absorption, or fluorescence after excitation of a sample (e.g., a solution comprising proteins) with light of a suitable wavelength.

In an aspect of the present invention, samples are actively sensed by optical detectors 13, 15 which recognize changes in a source light (e.g., such as a ultraviolet source) reacting with the samples.

In one aspect, a detector 13, 15 is provided which detects the native fluorescence of a sample which passes through the detector 13, 15. Such fluorescence arises from the presence of tryptophan, tyrosine, and phenylalanine residues in these molecules. In one aspect of the present invention, the detector 13, 15 comprises a laser (e.g., a 210-290 nm laser) for excitation of a sample as it passes within range of detection optics within the system and collects spectra emitted from the sample in response to this excitation. The detector 13, 15 can comprise a lens or objectives to further focus light transmitted from the laser or received from the sample.

The detector 13, 15 for detecting native fluorescence of a sample and which are able to spectrally differentiate at least tryptophan and tyrosine are known in the art, and described, for example in Timperman et al., 1995, Analytical Chemistry 67(19): 3421-3426, the entirety of hereby incorporated herein by reference. As discussed above, the detector 13, 15 can be used to monitor and control sample flow through the bi-directional CE device.

In one aspect of the present invention, an ultra violet (UV) or thermal lens detector 13, 15 can be used and integrated into the bi-directional capillary electrophoresis separation device 9. In one aspect of the present invention, a UV detection system with a multi-reflection cell is integrated into the bi-directional CE device 9.

In a preferred aspect of the invention, a detector 13, 15 is placed in optical communication with the separation channel 23, 24. The detector 13, 15 detects sample bands and a processor (not shown) in response to the signals received from the detector 13, 15 performs a background subtraction which eliminating background electrolyte signal.

In one aspect of the present invention, one or more detectors 13, 15 are electrically linked to a processor (not shown). As used herein, the term “linked” includes either a direct link (e.g., a permanent or intermittent connection via a conducting cable, an infra-red communicating device, or the like) or an indirect link such that data are transferred via an intermediate storage device (e.g., a server or a floppy disk). The output of the detector 13, 15 should be in a format that can be accepted by the processor.

Those of skill in the art will recognize that a variety of detectors 13, 15 can be selected according to the types of samples being analyzed. The detectors 13, 15 additionally can be coupled to cameras, appropriate filter systems, photomultiplier tubes, and similar devices. The detectors 13, 15 need not be limited to optical detectors, but can include any detector used for detection in liquid chromatography and capillary electrophoresis, including but not limited to, electrochemical, refractive index, backscatter interferometer, thermal lensing, conductivity, FT-IR, and light scattering detectors, and similar devices. Those of skill in the art will recognize that many other detectors are within the spirit and scope of the present invention.

As shown in FIG. 7, those skilled in the art will recognize that one dual channel detector 28 can be used to monitor both channels 23, 24 if the detection windows are brought in close enough proximity.

FIG. 3 also provides for a pressure outlet 17. In one embodiment of the present invention, the pressure outlet 17 is optional for bulk flow of solution.

FIG. 4 shows an embodiment of the present invention in which the pressure outlet (as shown in FIG. 3) has been removed. In this aspect of the present invention, bulk flow from an upstream separation must be split or sent to at least one of the capillary electrophoresis channels.

FIG. 5 shows an embodiment of the present invention in which the bi-directional capillary electrophoresis separation device 9 has been incorporated into an integrated microfluidic system for proteome analysis 31. Assignee's co-pending U.S. patent application Ser. No. 10/273,494, the entirety of which is hereby incorporated herein by reference, discloses an integrated microfluidic system for proteome analysis.

In one aspect of the present invention, the integrated microfluidic proteome analysis system 31 comprises an upstream separation module, preferably a multi-dimensional chromatography device comprising one or more separation columns or channels interfaced with at least one microfluidic module. The microfluidic module comprises a microfluidic device which is a substrate comprising one or more recipient channels for receiving substantially purified polypeptides from the upstream separation module. Preferably, the microfluidic device is covered by an overlying substrate which comprises openings communicating with the one or more channels of the device and through which solutions and/or reagents can be introduced into the channels. The overlying substrate also maintains the microfluidic module as a substantially contained environment, minimizing evaporation of solutions flowing through the channels of the microfluidic device.

In a preferred aspect, proteases are immobilized in one or more channels of a protease digestion device of at least one microfluidic module of the integrated microfluidic system for proteome analysis 31 generating an “on-device” protein digestion system. Still more preferably, as polypeptides travel through channels of the microfluidic module by mass transport, they are concentrated as they are digested by the proteases. In one aspect of the present invention, the microfluidic module is coupled at its downstream end to a downstream separation module (e.g., such as a capillary electrophoresis or CE module) which collects digested polypeptide products, i.e., peptides, and which can perform further separation of these peptides. The downstream separation module is in communication with a peptide analysis module (e.g., an electrospray tandem mass spectrometer or ESI-MS/MS) which is used to collect information relating to the properties of the individual peptides. One or more interfacing microfluidic modules also can be provided for interfacing the downstream separation module with the peptide analysis module.

In one aspect of the present invention, the integrated microfluidic system for proteome analysis 31 further comprises a system processor which can convert electrical signals obtained from different modules of the integrated microfluidic proteome analysis system 31 (and/or from their own associated processors or microprocessors) into information relating to separation efficacy and the properties of substantially separated proteins and peptides as they travel through different modules of the system. Preferably, the system processor also monitors the rates at which proteins/peptides move through different modules of the system. Preferably, signals are obtained from one or more detectors which are in optical communication with different modules and/or channels of the integrated microfluidic proteome analysis system 31. In one aspect of the present invention, the detectors are in communication with the upstream separation module and as such are able to deliver a sample plug to a correct location of the microfluidic module in order to undergo a digestion reaction.

The integrated microfluidic system for proteome analysis 31 can vary in the arrangements and numbers of components/modules within the system. For example, the number and arrangement of detectors can vary. In one aspect of the present invention, the protease digestion module can interface directly with the peptide analysis module without connection to an intervening downstream separation module and/or interfacing module or can interface to the downstream separation module and not an interfacing module, or to an interfacing module but not a downstream separation module. In some aspects of the present invention, the protease digestion module also can perform separation, eliminating the need for one or more separation functions of the upstream separation module. In still other aspects of the present invention, the interfacing module can be coupled to a separation module for connection to a peptide analysis module without connection to a microfluidic module. In this scenario, digested or partially digested polypeptides can be delivered to the separation module after being obtained from a protease digestion device not connected to the integrated microfluidic system for proteome analysis 31, or less preferably, after being obtained from an on-gel digestion process.

In other aspects of the present invention, although the integrated microfluidic proteome analysis system 31 is described as being “integrated” in the sense that the different modules complement each others' functions, various components of the integrated microfluidic proteome analysis system 31 can be used separately and/or in conjunction with other systems. For example, components selected from the group consisting of: the upstream separation module, protease digestion module, downstream separation module, interfacing module, and peptide analysis module, and combinations thereof, can be used separately. Additionally, some modules can be repeated within the integrated microfluidic system for proteome analysis 31, e.g., there may be more than one upstream and/or downstream separation module, more than one protease digestion module, more than one interfacing module, more than one detector, and more than one peptide analysis module within the integrated microfluidic proteome analysis system 31. It should be obvious to those of skill in the art that many permutations are possible and that all of these permutations are encompassed within the scope of the invention.

All references, patents, patent applications and patent publications cited are hereby incorporated herein by reference in their entireties. Variations, modifications, and other implementations of what is described herein will occur to those of ordinary skill in the art without departing from the spirit and scope of the present invention as claimed. Accordingly, the present invention is to be defined not by the preceding illustrative description.

We claim:

1. A bidirectional capillary electrophoresis device, comprising:
a middle column;
the middle column intersecting a first uncharged channel and a second uncharged channel at an intersection point wherein the middle column is approximately perpendicular to the first uncharged channel and the second uncharged channel; and
a negative electrode in communication with the first uncharged channel and a positive electrode in communication with the second uncharged channel,
wherein a mixture of anions and cations may be separated by drawing the cations toward the negative electrode and drawing the anions towards the positive electrode.

2. The device of claim 1 wherein the first channel comprises a slight charge.

3. The device of claim 1 wherein the first channel comprises a coating.

4. The device of claim 3 wherein the second channel comprises a coating.

5. The device of claim 3 wherein the coating is Triton X 100.

6. The device of claim 1 wherein a detector is in communication with the first uncharged channel.

7. The device of claim 1 wherein a first detector is in communication with the first uncharged channel to detect cations and a second detector is in communication with the second uncharged channel to detect anions.

8. The device of claim 1 further comprising a hydrodynamic flow resistor positioned in the first uncharged channel.

9. The device of claim 1 further comprising a pressure outlet.

10. The device of claim 1 wherein a dual channel detector is in communication with the first uncharged channel and the second uncharged channel.

11. The device of claim 1 wherein the first uncharged channel is a capillary.

12. A microfluidic bi-directional capillary electrophoresis device, comprising:
a middle column;
the middle column intersecting a first uncharged channel and a second uncharged channel at an intersection point wherein the middle column is approximately perpendicular to the first uncharged channel and the second uncharged channel; and
a negative electrode in communication with the first uncharged channel and a positive electrode in communication with the second uncharged channel,
wherein a mixture of anions and cations may be separated by drawing the cations toward the negative electrode and drawing the anions towards the positive electrode.

13. The device of claim 12 wherein the first uncharged channel is engaged to a first microfluidic system for proteome analysis.

14. The device of claim 13 wherein the second uncharged channel is engaged to a second microfluidic system for proteome analysis.

15. The device of claim 12 wherein the first channel comprises a slight charge.

16. The device of claim 12 wherein the first uncharged channel comprises a coating.

17. The device of claim 16 wherein the second channel comprises a coating.

18. The device of claim 16 wherein the coating is Triton X 100.

19. The device of claim 12 wherein a detector is in communication with the first uncharged channel.

20. The device of claim 12 wherein a first detector is in communication with the first uncharged channel to detect cations and a second detector is in communication with the second uncharged channel to detect anions.

21. The device of claim 12 further comprising a hydrodynamic flow resistor positioned in the first uncharged channel.

22. The device of claim 12 further comprising a pressure outlet.

23. The device of claim 12 wherein a dual channel detector is in communication with the first uncharged channel and the second uncharged channel.

24. A method of separating a sample of anions and cations, comprising:
delivering the sample to a middle column of a bi-directional capillary electrophoresis device;
providing a first uncharged channel and a second uncharged channel approximately perpendicular to the middle column wherein the middle column intersects the first uncharged channel and the second uncharged channel at an intersection point;
positioning a negative electrode in communication with the first uncharged channel thereby drawing cations into the first uncharged channel; and
positioning a positive electrode in communication with the second uncharged channel thereby drawing anions into the second uncharged channel.

25. The method of claim 24 wherein the first channel comprises a slight charge.

26. The method of claim 24 wherein the first uncharged channel comprises a coating.

27. The method of claim 26 wherein the second uncharged channel comprises a coating.

28. The method of claim 26 wherein the coating is 100 Triton-X.

29. The method of claim 24 further comprising:
placing a detector in communication with the first uncharged channel to detect cations.

30. The method of claim 29 further comprising:
placing a detector in communication with the second uncharged channel to detect anions.

31. The method of claim 24 further comprising:
placing a dual channel detector in communication with the first uncharged channel and the second uncharged channel.

32. The method of claim 24 further comprising:
placing a hydrodynamic flow resistor in communication with the first uncharged channel.

33. A method of separating a sample of anions and cations on a microfluidic device, comprising:
delivering the sample to a middle column of a b-idirectional capillary electrophoresis device;
providing a first uncharged channel and a second uncharged channel approximately perpendicular to the middle column wherein the middle column intersects the first uncharged channel and the second uncharged channel at an intersection point;
positioning a negative electrode in communication with the first uncharged channel thereby drawing cations into the first uncharged channel; and
positioning a positive electrode in communication with the second uncharged channel thereby drawing anions into the second uncharged channel.

34. The method of claim 33 wherein the first channel comprises a slight charge.

35. The method of claim 33 wherein the first uncharged channel comprises a coating.

36. The method of claim 35 wherein the second uncharged channel comprises a coating.

37. The method of claim 35 wherein the coating is 100 Triton-X.

38. The method of claim 33 further comprising:
placing a detector in communication with the first uncharged channel to detect cations.

39. The method of claim 38 further comprising:
placing a detector in communication with the second uncharged channel to detect anions.

40. The method of claim 33 further comprising:
placing a dual channel detector in communication with the first uncharged channel and the second uncharged channel.

41. The method of claim 33 further comprising:
placing a hydrodynamic flow resistor in communication with the first uncharged channel.

42. The method of claim 33 further comprising:
engaging the first uncharged channel to a first microfluidic proteome analysis system.

43. The method of claim 42 further comprising:
engaging the second uncharged channel to a second microfluidic proteome analysis system.
